(19) United States
(12) Patent Application Publication
(10) Pub. No.: US 2011/0087434 A1
(43) Pub. Date: Apr. 14, 2011

(54) MONITORING SYSTEM

(75) Inventor: Terje Lennart Lie, Garnes (NO)

(73) Assignee: TECWEL AS, Laksevag (NO)

(21) Appl. No.: 12/866,628

(22) PCT Filed: Feb. 7, 2008
(86) PCT No.: PCT/NO2008/000045

§ 371 Date: Dec. 8, 2010

(51) Int. Cl. G06F 19/00; G01V 5/00

(52) U.S. Cl. 702/8; 702/6

(57) ABSTRACT

There is provided a monitoring system (300) for monitoring within a borehole (10). The system (300) comprises a probe assembly (100) operable to be moved within the borehole (10) for sensing one or more physical parameters therein, a data processing arrangement (110) located outside the borehole (10), and a data communication link (120) operable to convey sensor data indicative of the one or more physical parameters from the probe assembly (100) to the data processing arrangement (110) for subsequent processing and display and/or recording in data memory (140). The probe assembly (100) includes one or more sensors (320) for spatially monitoring within the borehole (10) and generating corresponding sensor signals (360). Moreover, the probe assembly (100) includes a digital signal processor (310) for executing preliminary processing of the sensor signals (360) to generate corresponding intermediately processed signals (370) for communication via the data communication link (120) to the data processing arrangement (110). Furthermore, the data processing arrangement (110) is operable to receive the intermediately processed signals (370) and to perform further processing on the intermediately processed signals (370) to generate output data for presentation (130) and/or for recording in a data memory arrangement (140). The system (300) is of benefit in that it enables real-time spatial monitoring of the borehole (10) to be achieved.

### FIELD OF THE INVENTION

The present invention relates to monitoring systems, for example to monitoring systems for monitoring boreholes in connection with oil and/or gas exploration and/or extraction. Moreover, the present invention is concerned with methods of monitoring boreholes in connection with oil and/or gas exploration and/or extraction. Furthermore, the present invention also relates to software products for use in implementing these aforesaid methods.

### BACKGROUND OF THE INVENTION

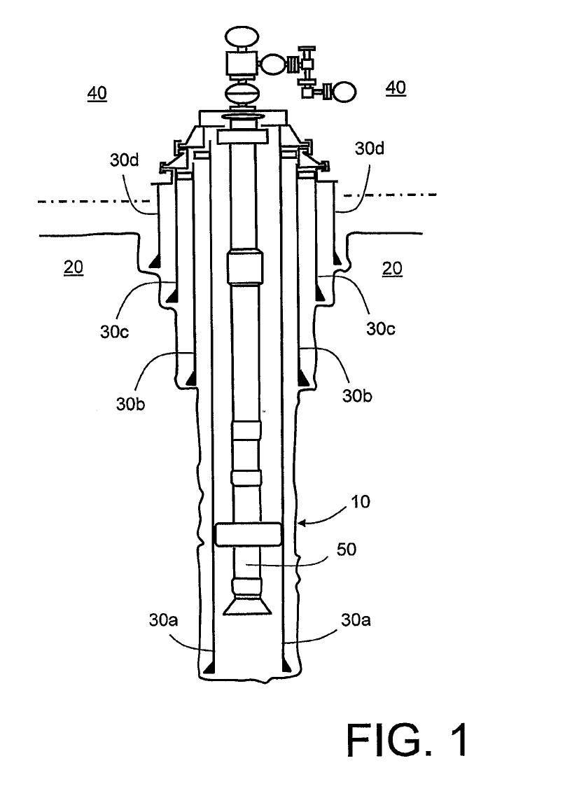

Referring to FIG. 1, a borehole indicated generally by 10 is formed in a region of ground 20 during gas and/or oil exploration. In an event that deposits of oil and/or gas are found substantially at an end of the borehole 10, the borehole 10 provides a route by which the oil and/or gas deposits can be subsequently extracted. The borehole 10 is often several kilometres in depth and filled with liquid, for example:
(a) with drilling mud when executing boring operations during oil and/or gas exploration; and
(b) with a multiphase mixture of oil, water and sand particles during subsequent oil extraction, namely during production.

In such circumstances, a relatively elevated pressure is often encountered at the end of the borehole 10, for example in an order approaching 1000 Bar. Moreover, on account of geothermal heating in lower strata of the region of ground 20, an ambient temperature within the borehole 10 is susceptible to approaching 150° C. for more. Furthermore, the region of ground 20 is potentially porous and susceptible to fragmenting into quantities of gravel and similar types of sand particles.

In order to successfully drill the borehole 10, it is conventional practice to line the borehole 10 along at least part of its depth with one or more liner tubes 30a, 30b, 30c, 30d. The liner tubes 30a to 30d are operable, for example, to prevent water and other contaminants penetrating into the borehole 10 at upper regions of the ground 20. Moreover, the liner tubes 30a, 30b, 30c, 30d are also operable to reduce leakage of oil and/or gas from the borehole 10. For reasons of economy, the borehole 10 is drilled to have a diameter sufficient for accommodating drilling and/or extraction apparatus 50 as well as providing for gas and/or oil extraction; the borehole 10 is not made to be unnecessarily large because drilling time to form the borehole 10 and associated costs would thereby be unnecessarily increased. In practice, the liner tube 30a is conveniently in an order of 200 mm in diameter.

Many practical problems are often encountered when drilling the borehole 10; moreover, subsequent problems can arise when extracting oil and/or gas via the borehole 10. An example of such problems is that the liner tube 30a develops one or more leakage holes. The one or more leakage holes are susceptible to enabling water and sand present in the region of ground 20 to penetrate into a central region of the liner tube 30a; alternatively, the one or more leakage holes are susceptible to resulting in a loss for oil and/or gas from the liner tube 30a into the ground 20, thereby reducing yield of oil and/or gas from the borehole 10. Moreover, the liner tube 30a itself is potentially susceptible to becoming obstructed with deposits transported up the liner tube 30a, for example sand/oil/tar deposits. Furthermore, a flow of liquid and/or gas in an external region between the liner tube 30a and the ground 20 is also susceptible to occurring which can result in potential pollution, combustion risk and/or a loss of pressure within the borehole 10; maintaining a high pressure in the borehole 10 is, for example, desirable for achieving an enhanced rate of oil and/or gas delivery from the borehole 10. When aforementioned one or more leakage holes and/or obstructions occur many kilometres underground, it is often very difficult to know at an above-ground region 40 what precisely is happening in the ground 20 in respect of the borehole 10. In view of the borehole 10 potentially costing many millions of dollars (US dollars) to drill and prepare for subsequent oil and/or gas extraction, reliable and efficient detection of defects arising in the borehole 10 is of considerable commercial importance. However, physical conditions within the borehole 10, for example in lower regions thereof, are very hostile on account of abrasive particles present, high ambient temperatures in an order of 150° C. or more, high pressure approaching 1000 Bar and corrosive and/or penetrative fluids present in the borehole 10.

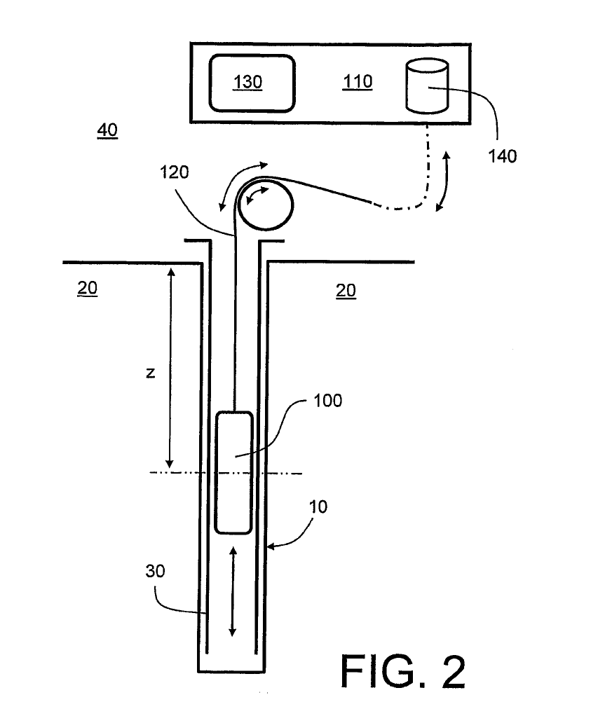

Various types of down-borehole tools are known, for example for measuring multiphase fluid composition within boreholes. Referring to FIG. 2, certain implementations of these tools each comprise a probe assembly 100 operatively inserted into the borehole 10 to be monitored, a data processing arrangement 110 in the above-ground region 40, and a flexible communication link 120 mutually coupling together the data processing arrangement 110 and the probe assembly 100. In operation, the probe assembly 100 senses one or more parameters within the borehole 10, for example temperature and/or pressure therein, using one or more sensors to generate one or more sensor signals which are then communicated via the communication link 120 to the data processing arrangement 110. At the data processing arrangement 110, the one or more sensor signals are at least one of: displayed on a display 130 in real-time, recorded in a data memory or data base 140 for subsequent analysis. Implementations of the tools, for example as illustrated in FIG. 2, optionally enable real-time monitoring of boreholes to be achieved. A sliding fluid seal (not shown in FIG. 2) is formed at the top of borehole 10 around a cable implementing the communication link 120 so as to seal the borehole 10 in an event that the borehole 10 is operating under excess pressure, for example as a result the borehole 10 intercepting a gas deposit in the ground region 20.

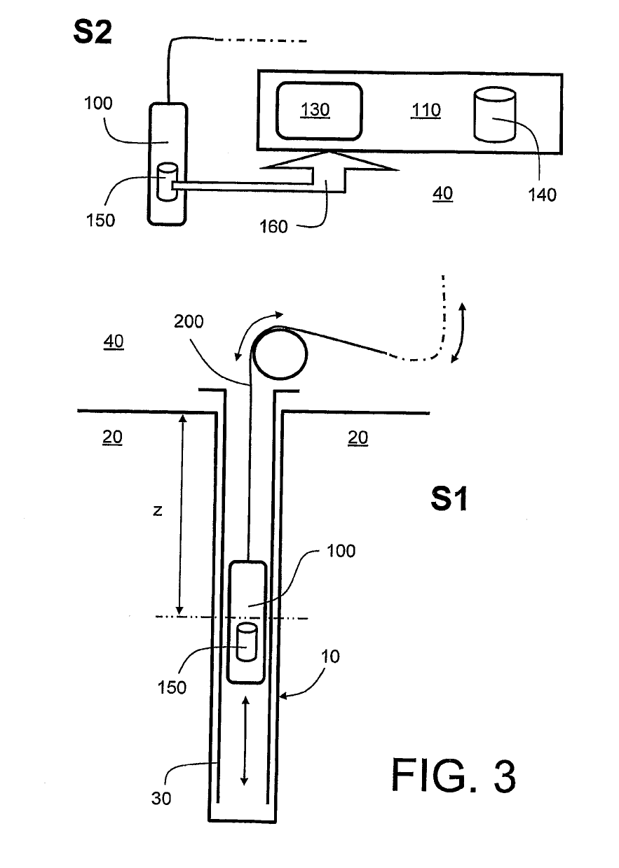

Alternatively, as illustrated in FIG. 3, other implementations of these tools each comprise the probe assembly 100 which additionally includes a semiconductor data memory 150 locally therein for recording signals generated by one or more sensors of the probe assembly 100 in a first step S1 when the probe assembly 100 is employed to characterize the borehole 10. In such an implementation, the probe assembly 100 is operable to function as an autonomous apparatus which is moved substantially blindly within a borehole 10 to collect data therefrom. In a step S2, the probe assembly 100 is then subsequently extracted from the borehole 10 to the above-ground region 40, whereat the probe assembly 100 is coupled to its associated data processing arrangement 110 for downloading monitoring data thereto, as denoted by 160, namely from the data memory 150 of the probe assembly 100 to the data processing arrangement 110.

A technical problem is encountered when the probe assembly 100 in FIG. 2 is employed to spatially inspect, for example by employing one or more optical cameras, an inside of a borehole 10 on account of a considerable amount of corresponding data which is generated. Measurements such as one or more temperatures within the borehole 10, one or more pressures within the borehole 10, and phase composition of fluid within the borehole 10 generally generate significantly less corresponding amounts of data in comparison to executing three-dimensional spatial inspection, for example 360° two-dimensional imaging and imaging resulting in perspective images of an inside of the borehole 10 being generated. In consequence, when spatial inspection is to be performed, severe technical demands are placed upon communication performance of the aforesaid communication link 120 in respect of data bandwidth, or upon data memory capacity which must be provided robustly within the probe assembly 100 when operated in an autonomous manner.

It is thus desirable to be able to spatially inspect, in real-time, an inside of a borehole by using a probe assembly. On detection of a defect such as a leakage hole or obstruction, it is desirable for the probe assembly to be maintained in a locality of the defect for a longer period to sample an enhanced amount of data, thereby enabling the defect to be identified and characterized to a greater degree of certainty. By identifying and characterizing one or more defects to a greater degree of certainty, repair or mitigation of the one or more defects are susceptible to being implemented in a more efficient and selective manner.

A technical problem which the present invention therefore addresses is at least partially resolving conflicting constraints of, firstly, real-time monitoring of a borehole and, secondly, providing spatial inspection of the borehole which have hitherto seemed impossible to adequately resolve.

### SUMMARY OF THE INVENTION

An object of the present invention is to provide an improved monitoring system which is operable to enable real-time monitoring of boreholes whilst also enabling spatial inspection of boreholes to be achieved.

According to a first aspect of the invention, there is provided a monitoring system as claimed in appended claim 1: there is provided a monitoring system for monitoring within a borehole, the system comprising a probe assembly operable to be moved within the borehole for sensing one or more physical parameters therein, a data processing arrangement being located outside the borehole, and a data communication link operable to convey sensor data indicative of the one or more physical parameters from the probe assembly to the data processing arrangement for subsequent processing and display and/or recording in data memory,

characterized in that
(a) the probe assembly includes one or more sensors for spatially monitoring within the borehole and generating corresponding sensor signals;
(b) the probe assembly includes a digital signal processor for executing preliminary processing of the sensor signals to generate corresponding intermediately processed signals for communication via the data communication link to the data processing arrangement; and
(c) the data processing arrangement is operable to receive the intermediately processed signals and to perform further processing on the intermediately processed signals to generate output data for presentation and/or for recording in a data memory arrangement.

The invention is of advantage in that preliminary processing executed within the digital signal processor is capable of reducing a quantity of measurement data to be communicated, thereby rendering possible real-time spatial monitoring of the borehole.

Thus, beneficially, the system is operable to generate the output data for presentation in real-time when the probe assembly is moved within the borehole.

Optionally, the system is implemented to be operable in at least one of first and second modes, wherein:
(a) the first mode results in the system passively sensing noise sources present in the borehole generating radiation for sensing at the one or more sensors; and
(b) the second mode results in the system actively emitting radiation into the borehole and receiving at the one or more sensors corresponding reflected radiation from a region in and/or around the borehole for generating the sensor signals.

The first mode is of benefit in that it enables sources of noise, for example leakage holes, failed seals, cracks and other types of defect through which fluids are capable of flowing and generating acoustic noise, to be detected.

More optionally, the system is operable to be dynamically reconfigurable between the first and second modes when the probe assembly is being moved in operation within the borehole. Such a feature to be able to dynamic reconfigure the system enables the system to detect in real-time a greater range of types of features and defects. However, the system is optionally adapted for operating specifically solely in the first mode or in the second mode.

Optionally, the system is operable to communicate data bi-directionally between the data processing arrangement and the probe assembly, wherein the digital signal processor of the probe assembly is operable to be reconfigured between a first function of generally sensing around in a region of the borehole in a vicinity of the probe assembly, and a second function of specific sensing in a sub-region of the region of the borehole in a vicinity of the probe assembly. Bi-directional communication enables the probe assembly to be reconfigured to occasionally concentrating on sensing certain sub-regions of the borehole of special interest, thereby using finite communication bandwidth provided by the communication link in an efficient manner.

Optionally, the system is implemented such that the one or more sensors are implemented as one or more ultrasonic transducer arrays disposed at one or more positions on the probe assembly including:
(a) as an array at a bottom surface of the probe assembly facing down the borehole when the probe assembly in inserted into the borehole in operation;
(b) one or more ring formations at one or more ends of the probe assembly, or radially around an radial side wall of the probe assembly; and
(c) in one or more rows or one or more spiral formations around a peripheral surface of the probe assembly in a substantially longitudinal direction along the probe assembly.

Optionally, the system is operable to process the sensor signals and compare the processed signals with one or more signal templates for automatically detecting features present in the borehole which are encountered in operation by the probe assembly. Such comparison is optionally based upon correlation and/or neural network analysis techniques.

Optionally, the system is implemented such that the data communication link comprises one or more twisted-wire pairs including plastics material insulation and copper electrical conductors embedded within the plastics material, the data communication link being clad by cladding susceptible to bearing a weight of the probe assembly when the assembly is moved in operation within the borehole. Use of twisted pairs is of benefit in providing a reliable and stable line impedance for electrical signals and thereby substantially avoiding end reflections of electrical signals when appropriately-matched line drivers and receivers are employed, whilst providing a mechanically robust implementation when the probe assembly is manoeuvred in the borehole.

Optionally, the system is implemented such that the data communication link comprises one or more twisted-wire pairs including plastics material insulation and copper electric conductors embedded within the plastics material, the data communication link being provided with an associated mechanical element susceptible to bearing a weight of the probe assembly when the assembly is moved in operation within the borehole.

Optionally, the monitoring system is implemented such that the data processing arrangement is located in operation remotely from the probe assembly, the data processing arrangement providing an interface for one or more users to control in real-time operation of the probe assembly, and for generating graphical images for presenting on one or more displays to the one or more users, the graphical images being representative of spatial features present within and/or around the borehole in a vicinity of the probe assembly.

According to a second aspect of the invention, there is provided a method of monitoring within a borehole as claimed in appended claim 11: there is provided a method of monitoring within a borehole by using a monitoring system, the system comprising a probe assembly operable to be moved within the borehole for sensing one or more physical parameters therein, a data processing arrangement located outside the borehole, and a data communication link operable to convey sensor data indicative of the one or more physical parameters from the probe assembly to the data processing arrangement for subsequent processing and display and/or recording in data memory,

characterized in that the method includes steps of:
(a) spatially monitoring using one or more sensors of the probe assembly within the borehole and generating corresponding sensor signals;
(b) using a digital signal processor included in the probe assembly, executing preliminary processing of the sensor signals for generating corresponding intermediately processed signals;
(c) communicating via the data communication link the intermediately processed signals to the data processing arrangement; and
(d) receiving the intermediately processed signals at the data processing arrangement for performing further processing on the intermediately processed signals for generating output data for presentation and/or for recording in a data memory arrangement.

Optionally, the method includes a further step of:
(e) generating using the system the output data for presentation in real-time when the probe assembly is moved within the borehole.

Optionally, the method is implemented such that the monitoring system is operable in at least one of first and second modes, wherein:
(a) the first mode results in the system passively sensing noise sources present in the borehole generating radiation for sensing at the one or more sensors; and
(b) the second mode results in the system actively emitting radiation into the borehole and receiving at the one or more sensors corresponding reflected radiation from a region in and/or around the borehole for generating the sensor signals.

More optionally, the method includes a further step of dynamically reconfiguring the system between the first and second modes when the probe assembly is being moved in operation within the borehole. Such dynamic reconfiguring enables more diverse types of features to be monitored substantially simultaneously using the system in real-time.

Optionally, the method includes a step of:
(f) communicating data bi-directionally between the data processing arrangement and the probe assembly, wherein the digital signal processor of the probe assembly is operable to being reconfigured between a first function of generally sensing around in a region of the borehole in a vicinity of the probe assembly, and a second function of specific sensing in a sub-region of the region of the borehole in a vicinity of the probe assembly.

Optionally, when implementing the method, the one or more sensors are implemented as one or more ultrasonic transducer arrays disposed at one or more positions on the probe assembly including:
(a) as an array at a bottom surface of the probe assembly facing down the borehole when the probe assembly in inserted into the borehole in operation;
(b) one or more ring formations at one or more ends of the probe assembly, or radially around an radial side wall of the probe assembly;
(c) in one or more rows or one or more spiral formations around a peripheral surface of the probe assembly in a substantially longitudinal direction along the probe assembly.

Optionally, the method includes a further step of:
(g) processing the sensor signals to generate corresponding processed signals; and then
(h) comparing the processed signals with one or more signal templates for automatically detecting features present in the borehole which are encountered in operation by the probe assembly.

Optionally, when employing the method, the data communication link is beneficially implemented using one or more twisted-wire pairs including plastics material insulation and copper electric conductors embedded within the plastics material, the data communication link being clad by cladding susceptible to bearing a weight of the probe assembly when the assembly is moved in operation within the borehole. Such an implementation of the data communication link is susceptible to providing a suitable compromise between data communication rate, robustness and acceptable manufacturing cost, especially bearing in mind that the communication link and its associated cladding is potentially many kilometres long and has to be able to bear its own weight.

Optionally, when employing the method, the data communication link is beneficially implemented using one or more twisted-wire pairs including plastics material insulation and copper electric conductors embedded within the plastics material, the data communication link being provided with a mechanical element susceptible to bearing a weight of the probe assembly when the assembly is moved in operation within the borehole.

Optionally, the method includes a step of:
(i) locating the data processing arrangement in operation remotely from the probe assembly, the data processing arrangement providing an interface for one or more users to control in real-time operation of the probe assembly, and for generating graphical images for presentation on one or more displays to the one or more users, the graphical images being representative of spatial features present within and/or around the borehole in a vicinity of the probe assembly.

According to a third aspect of the invention, there is provided a computer software product recorded on a data carrier, the computer software product being executable on computing hardware for implementing a method pursuant to the second aspect of the invention.

According to a fourth aspect of the invention, there is provided a probe assembly for monitoring in a borehole, the probe assembly being adapted for use in the system pursuant to the first aspect of the invention.

Features of the invention are susceptible to being combined in any combination without departing from the scope of the invention as defined by the appended claims.

### DESCRIPTION OF THE DIAGRAMS

Embodiments of the present invention will now be described, by way of example only, with reference to the following diagrams wherein:

FIG. 1 is an illustration of a borehole furnished with a liner tube arrangement;

FIG. 2 is a schematic illustration of a down-borehole probe arrangement for sensing physical parameters within a borehole and generating corresponding signals for communicating in real-time to a data processing arrangement remote from the borehole;

FIG. 3 is a schematic illustration of a down-borehole probe arrangement for sensing physical parameters within a borehole and generating corresponding signals for data-logging locally within a probe assembly, for subsequent down-loading to a data processing arrangement when the probe assembly has been extracted from the borehole;

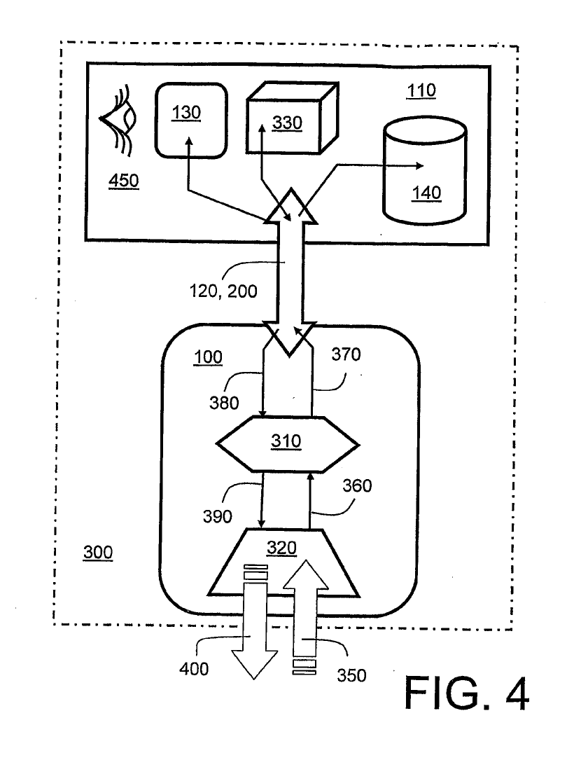

FIG. 4 is a schematic illustration of a monitoring system pursuant to the present invention for monitoring down boreholes;

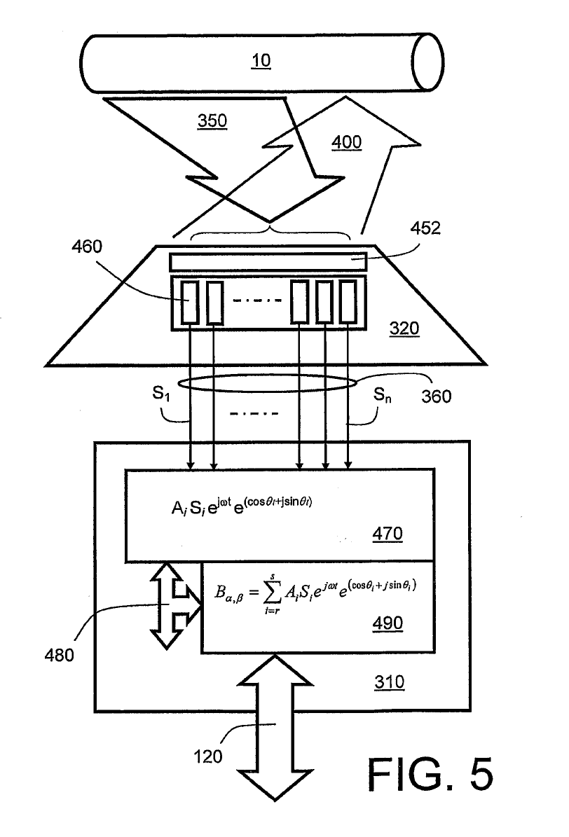

FIG. 5 is a more detailed illustration of component parts of the system in FIG. 4, the components including a transducer array for receiving ultrasonic radiation from boreholes, and optionally for also interrogating such boreholes;

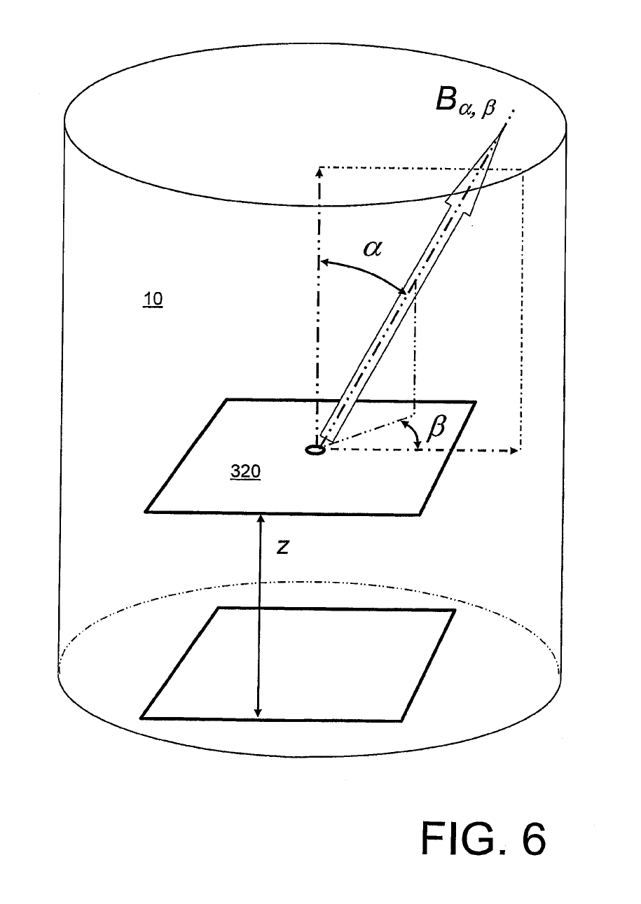

FIG. 6 is an illustration of polar sensing angles of the transducer array of FIG. 5;

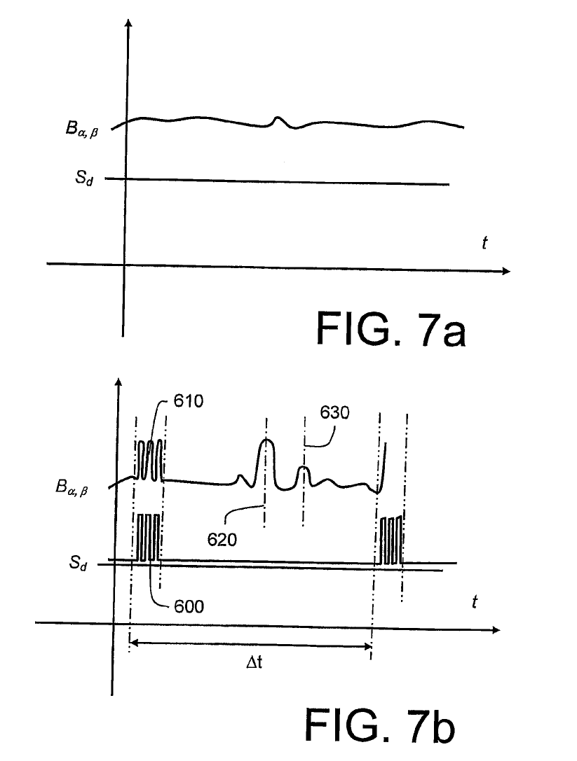

FIGS. 7a and 7b are illustrations of signals present in the system of FIG. 4 when in operation;

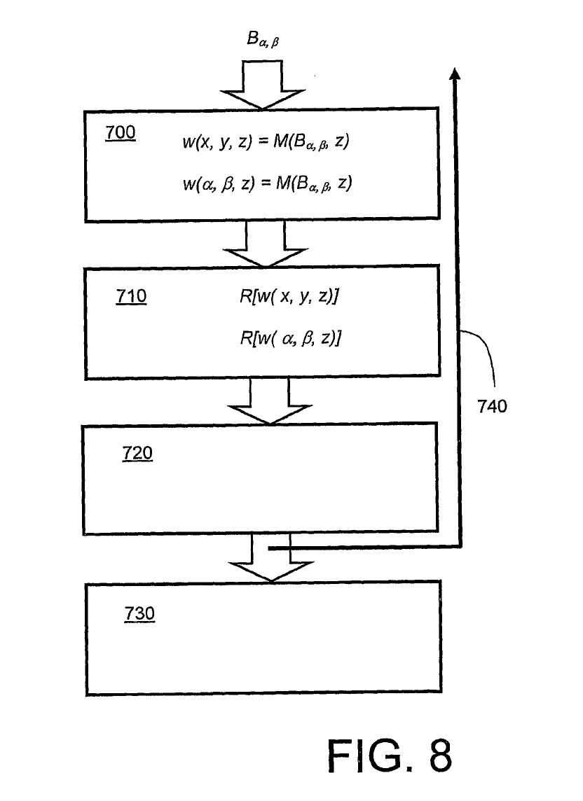

FIG. 8 is a flow diagram of signal processing operations executed within the system of FIG. 4; and

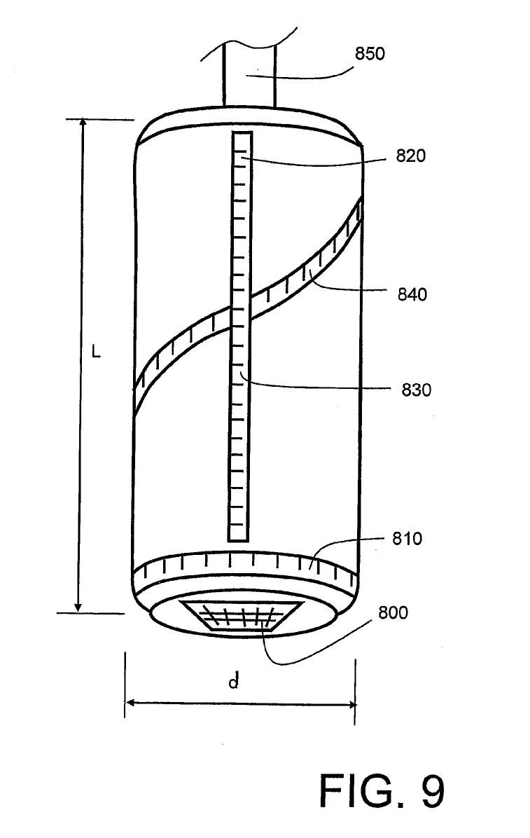

FIG. 9 is an illustration of a probe assembly of the system of FIG. 4 providing examples of configurations of transducer array which are optionally included in the probe assembly.

### DESCRIPTION OF EMBODIMENTS OF THE INVENTION

In overview, embodiments of the present invention include principal features akin to FIG. 2, namely:
(a) a probe assembly 100 for spatially sensing within a borehole 10;
(b) a communication link 120 whose associated cladding or mechanical structural core is operable to mechanically support the probe assembly 100 when deployed within the borehole 10, and whose signal guiding components are operable to convey signals transmitted from the probe assembly 100, and to convey control signals to the probe assembly 100;
(c) a data processing arrangement 110 coupled via the communication link 120 to the probe assembly 100, the data processing arrangement 110 being operable to receive signals from the probe assembly 100 and to send instruction signals to the probe assembly 100.

The probe assembly 100, the communication link 120 and the data processing arrangement 110 constitute a system as denoted by 300 in FIG. 4; the system 300 constitutes an embodiment of the present invention.

The system 300 is distinguished from subject matter presented and described in respect of FIG. 2 in that:
(a) the probe assembly 100 includes a transducer array 320 comprising one or more sensors coupled via a digital signal processor (DSP) 310 and then via the communication link 120 to the data processing arrangement 110; and
(b) the data processing arrangement 110 includes a data processor 330 which is operable to receive data from the probe assembly 100 via the communication link 120; the data processor 330 is also operable to send control commands via the communication link 120 to reconfigure the digital signal processor (DSP) 330, for example in response to one or more signals generated in operation by the transducer array 320.

The system 300 is optionally susceptible to operating in at least one of a first passive mode and a second active mode.

In the first passive mode, one or more physical signals 350 that are generated in an environment of the borehole 10 propagate within the borehole 10 and are eventually received by the transducer array 320. The transducer array 320 generates one or more corresponding electrical signals 360 which are conveyed to the digital signal processor (DSP) 310. Thereafter, the digital signal processor 310 performs primary processing of the one or more electrical signals 360 to generate corresponding intermediate processed signals 370 which are communicated via the communication link 120 to the data processor 330. The data processor 330 then performs secondary processing on the intermediate processed signals 370 to generate corresponding output data. Moreover, the data processor 330 is optionally operable to store at least part of the intermediate processed signals 370 in the data memory 140. Moreover, the data processor 330 is optionally operable to store at least part of the output data in the data memory 140. Moreover, the data processor 330 is operable to present the output data on the display 130.

In the second active mode, the data processor 330 is operable to send control signals 380 to the digital signal processor (DSP) 310 to drive the transducer array 320 with one or more drive signals 390 to cause the transducer array 320 to emit radiation 400 into the borehole 10. Optionally, the emitted radiation 400 is pulsed radiation comprising pulses punctuated by quiet periods; portions of the radiation 400 reflected from structures within and in near proximity to the borehole 10 are received back at the transducer array 320 as the one or more physical signals 350 to generate the corresponding one or more electrical signals 360 which are subsequently processed in the digital signal processor 310 to subsequently generate the intermediate processed signals 370. The data processor 330 then performs secondary processing of the intermediate processed signals 370 to generate corresponding output data. Moreover, the data processor 330 is optionally operable to store at least part of the intermediate processed signals 370 in the data memory 140. Moreover, the data processor 330 is optionally operable to store at least part of the output data in the data memory 140. Moreover, the data processor 330 is operable to present the output data on the display 130.

The system 300 is optionally designed to be able to switch dynamically between the aforementioned first passive mode and second active mode. Alternatively, the system 300 is optionally designed to function only in the first passive mode, for example optimized to function in the first passive mode. Yet alternatively, the system 300 is optionally designed to function only in the second active mode, for example optimized to function in the second active mode.

It will be appreciated from the foregoing that the system 300 is operable to distribute data processing activities between the digital signal processor 310 and the data processor 330. Such a distribution of data processing activities is of benefit in that data reduction within the probe assembly 100 is feasible to achieve so that available bandwidth of the communication link 120 is not occupied by data which bears relatively irrelevant information. By such data reduction, for example achieved by various data compression techniques which will be described in more detail later, it becomes feasible to provide real-time images of the borehole 10 on the display 130 at a sampling rate which is practical for the probe assembly 100 to be moved at an acceptably fast velocity up or down the borehole 10 for investigating defects therein or in a vicinity thereof. When the borehole 10 is many kilometres in length, an inspection rate when using the system 300 beneficially corresponds to several metres per second along the borehole 10. It is desirable that the system 300 is operable to perform metrology on the borehole 10 within a time period of 1 to 20 hours when the borehole 10 has a length in an order of kilometres. When the borehole 10 is implemented for gas extraction, the system 300 is susceptible to being used concurrently with gas extraction being performed.

The system 300 has been described in overview in the foregoing. However, before describing component parts of the system 300 in greater detail, other issues regarding the probe assembly 100 will next be elucidated. The borehole 10 is often at a pressure P which, in certain circumstances, can approach 1000 Bar. For example, the borehole 10 can often be many kilometres deep and filled with water, or with an abrasive multiphase mixture including oil, water and rock particles. When the probe assembly 100 is lowered into the borehole 10 filled with liquid to a depth of a kilometre or more, the pressure P acting upon the probe assembly 100 is potentially enormous. In such circumstances, a leakage hole in the liner tube 30a with many Bar differential pressure between a first region outside the liner tube 30a to a second region inside the liner tube 30a potentially results in a considerable flow of fluid between the first and second regions causing turbulent generation of acoustic radiation from a vicinity of the leakage hole. It is also feasible in certain situations that the borehole 10 is filled with gas at a high pressure approaching 1000 Bar on account of the borehole 10 intercepting a gas reservoir. Such high pressures in the borehole 10 risk forcing gas or liquid to ingress into an inside region of the probe assembly 100 and can also force gas into a polymeric material from which the cladding 200 is fabricated. For example, if the cladding is fabricated from polymeric material and is suddenly depressurized from a high pressure of 1000 Bar pressure to nominal atmospheric pressure of 1 Bar (760 mm Hg), gas forced by such a high pressure to earlier ingress into interstitial spaces within the polymeric material is susceptible to cause the polymeric material to expand to form a foam-like material with microvoids therein, potentially resulting in permanent damage to the polymeric material. Optionally, as illustrated in FIG. 1, the inner liner tube 30a includes a seal around a top region thereof as illustrated in FIG. 1 when the borehole 10 is required in operation to exhibit an elevated pressure relative to ambient atmospheric pressure of nominally substantially 1 Bar (760 mm Hg). The seal is beneficially adapted to be capable of sealing around the cladding 200, for example in a sliding manner, when the probe assembly 100 is deployed within the borehole 10. Although a use of a polymeric material to form the cladding 200 to clad the communication link 120 is virtually unavoidable, a casing of the probe assembly 100 is beneficially fabricated from a robust material which is resistant to abrasion and corrosion, for example fabricated from machined solid stainless steel material or seamless stainless steel tubing. Alternatively, or additionally, at least a portion of the probe assembly 100 can be fabricated from more exotic materials, for example advanced rigid polymer materials, silicon nitride material, and/or ceramic material for example.

The transducer array 320 is beneficially implemented as an array of one or more piezo-electric elements, for example fabricated from lead zirconate titanate (PZT) or similar strongly piezo-electric material. In operation, the transducer array 320 is susceptible to being excited by the one or more drive signals 390 applied thereto to generate the radiation 400 as ultrasonic radiation, and also susceptible to receive the radiation 350 as reflected ultrasonic radiation for generating aforesaid one or more electrical signals 360. Piezo electric material of the transducer array 320 is optionally directly in physical contact with fluid present within the borehole 10 in order to obtain most efficient coupling of ultrasonic radiation. Alternatively, the transducer 320 is operable to communicate with the interior region of the borehole 10 via one or more interfacing windows.

On account of the borehole 10 being potentially heated up to a temperature T approaching 150° C. by geothermal energy in rock formations surrounding the borehole 10, there is a potentially severe limitation regarding power dissipation which can occur within the probe assembly 100 when in operation. When the probe assembly 100 is operating pursuant to the aforesaid second active mode, generating the one or more drive signals 390 in drive amplifiers is susceptible to resulting in electrical power dissipation within the probe assembly 100. Moreover, data processing occurring in operation in the digital signal processor (DSP) 310 is susceptible to causing additional dissipation in both the first passive mode and in the second active mode.

Optionally, the digital signal processor (DSP) 310 is provided with one or more Peltier cooling elements for optionally cooling the signal processor 310; however, use of the one or more Peltier cooling element is susceptible to adding to a total dissipation occurring within the probe assembly 100 and is therefore only employed selectively where effective cooling of the processor 310 is susceptible to being thereby achieved.

The digital signal processor (DSP) 310 is beneficially implemented using semiconductor devices based upon CMOS technology which are not vulnerable to thermal runaway as a result of increase in minority-carrier currents therein during operation. Similarly, the drive amplifiers employed within the probe assembly 100 to provide the one or more drive signals 390 are beneficially also based upon MOSFET devices which are capable of operating at elevated temperatures approaching 200° C. without suffering thermal runaway.

Alternatively, or additionally to employing the one or more Peltier cooling elements, the signal processor 310 is implemented using several integrated circuits to spread power dissipation and therefore try to avoid hot-spots wherein a silicon die of an integrated circuit is at an elevated temperature relative to its local environment on account of dissipation occurring within the die during operation. Optionally, the several integrated circuits are fabricated as a hybrid module, for example including a ceramic substrate providing a low thermal resistance path to an ambient environment within the probe assembly 100.

On account of the liner tube 30a having an inside diameter in an order of 200 mm, the probe assembly 100 is manufactured to have a diameter in a range of 100 mm to 180 mm, more preferably to have a diameter of substantially 150 mm. Moreover, the cladding 200 of the communication link 120 is optionally required to be strong enough to bear a weight of the probe assembly 100 when lowered kilometres down the borehole 10 including a weight of the cladding itself; alternatively, or additionally, one or more mechanical supporting elements, for example one or more high-tensile steel ropes, are optionally employed to bear a weight of the probe assembly 100 when deployed in the borehole 10. If the cladding 200 is relatively larger in diameter, for example 25 mm or greater in diameter, it becomes too massive and is difficult to bend around pulleys of feed hoists above the borehole 10. Conversely, if the cladding 200 is relatively small in diameter, for example 4 mm or smaller in diameter, the cladding 200 is susceptible to becoming snarled on projections forming in operation on an inside-facing surface of the borehole 10 and is potentially unable to reliably bear its own weight and also the weight of the probe assembly 100. In practice, with modern advanced cladding materials, for example by using one or more of carbon fibres, Kevlar and advanced nano-material fibres, it is feasible to provide sufficient robustness for the cladding 200 when the cladding has a diameter in a range 5 mm to 15 mm, more preferable a diameter in a range of 6 mm to 10 mm, and most preferably a diameter of substantially 8 mm.

In operation, the cladding 200 is susceptible to exhibiting strain when a stress arising from weight is applied thereto. Optical fibres are not robust to stretching and can potentially be fractured when undergoing even modest longitudinal strain. In consequence, the communication link 120 is implemented as one or more electrical twisted pairs of wires. Optionally, the one or more electrical twisted pairs of wires are included within one or more overall electrically-conductive braided screens or similar. The wires each include plastics material insulation which is capable of stretching under stress. Moreover, each wire includes copper conductors therein; copper is a ductile metal of relatively low weight, of high electrical conductivity, of relatively high resistance to oxidative corrosion, and is less prone to work hardening when subjected to repeated bending cycles in comparison to other metals. At each end of the communication link 120 is included Ethernet line drivers matched to a transmission-line impedance of the one or more twisted-wire pairs of the communication link 120; data is thereby bi-directionally communicated in operation along the communication link 120 which is capable of enabling a data flow of several hundred kbytes per second to be supported. It is however to be bourn in mind that conventional real-time streaming of two-dimensional video images often requires a communication bandwidth in the order of MHz.

The data processing arrangement 110 is implemented as a configuration of proprietary components and is susceptible to being installed: on-land, on a sea-going vessel, in a submarine, on an oil exploration platform, or on an air-borne vehicle via an additional wireless link. The data processor 330 and the display 130 are beneficially implemented using proprietary computing hardware; the data processor 330 beneficially has a data entry device, for example a keyboard and a computer tracker-ball mouse, for enabling one or more users 450 to control operation of the system 300 in real-time. The data processor 330 is coupled in communication with the data memory 140 which is conveniently implemented by using at least one of: semiconductor memory, optical data memory, magnetic data memory.

Operation of the system 300 will now be described in greater detail.

During exploratory drilling activities for gas and/or oil, expensive and complex equipment is used under the supervision of experienced technical staff. In consequence, drilling and lining the borehole 10 with the liner tubes 30 is an extremely expensive activity, for example often costing in a region of a million United States dollars per day. When such high costs are encountered, problems occurring within the borehole 10 need to be identified quickly and resolved promptly. Even an operation of removing a drill bit and its associated string from the borehole 10 is a major undertaking, in some cases corresponding to several days of expensive work. When applied to monitor the borehole 10, for example after removal of a drill bit and associated drive string therefrom, the system 300 needs to be highly reliable, susceptible to being rapidly deployed into the borehole 10, and to provide flexibility in use by way of real-time monitor to avoid a need to repeatedly reinsert the probe assembly 100 into the borehole 10 when performing metrology thereon and monitoring thereof.

Referring to FIG. 5, the transducer array 320 comprises an array of one or more piezo-electric transducer elements 460 operable to at least receive ultrasonic radiation denoted by the radiation 350 from the borehole 10; there are n transducer elements in the transducer array 320, wherein a number n is beneficially in a range of one to several thousand, more preferable a plurality of transducer elements. As elucidated in the foregoing, the radiation 350 is generated by one or more processes occurring in the borehole 10 when the system 300 is operating in the first passive mode, and is generated by reflection of the radiation 400 when the system 300 is operating in the aforesaid second active mode. As described earlier, the array of transducer elements 460 optionally ultrasonically communicate via an interfacing member 452 which transmits ultrasonic radiation therethrough as well as protects the transducer elements 460 from a harsh environment within the borehole 10.

The one or more transducer elements 460 in the transducer array 320 are operable to generate signals Sᵢ e^{jωt} wherein i is in a range of 1 to n; the signals Sᵢ correspond to the electrical signals 360 described earlier. Beneficially, one or more of the transducer elements 460 are operable to emit and/or receive ultrasonic radiation having a frequency in a range of 100 kHz to 10 MHz when the system is operating pursuant to the second active mode, and more preferably in a range of 500 kHz to 5 MHz. Such a frequency range is of benefit it that individual transducer elements are susceptible to being implemented in a compact manner and that ultrasound at such frequency has a relatively short wavelength in an order of 1 mm. Conversely, one or more of the transducer elements 460 are operable to receive ultrasonic radiation having a frequency in a range of a few hundred Hz to several hundred kHz when the system 300 is functioning in the first passive mode, depending on which type of monitoring is to be performed within the borehole 10. The digital signal processor 310 is operable to condition one or more of the signals Sᵢ in a manner of a phased array algorithm to steer a direction of greatest sensitivity of the transducer array 320. Such steering is achieved by performing two principal steps in the digital signal processor 310.

The first step of beam forming involves selectively phase shifting and scaling the signals Sᵢ under control of various control parameters. Moreover, the first step is performed in computing hardware of the digital signal processor 310 operable to execute a software product stored on a data carrier, for example the data carrier being a non-volatile semiconductor data memory associated with the digital signal processor 310. In the first step, the signals S₁ are subject to scaling and phase shifting operations as defined by Equation 1 (Eq. 1) to generate corresponding intermediate processed signals Hᵢ:

Hᵢ=AᵢSᵢe^{jωt}e^{cosθ}^{₁}^{+j sin θ}^{₁}

wherein

j=square route of −1;

ω=angular frequency of signal component of interest;

t=time;

θᵢ=phase shift applied for beam forming purposes;

Aᵢ=scaling coefficient for beam forming purposes.

The second step of beam forming selectively summing one or more of the intermediate processed signals H, as defined by Equation 2 (Eq. 2) to generate corresponding signals B_{α,β} representative of a component of radiation received at the transducer array 320 from a specific direction as follows:

$${B}_{α , β} = {\sum }_{i = r}^{s} {H}_{i} \qquad Eq . 2$$

wherein
α, β=angles define the specific direction relative to an orientation of the transducer array 320 in which the transducer array 320 is preferentially sensitive for generating the signal B_{α,β}; and
r, s=index values defining which intermediate signals Hᵢ to be selectively summed to generate the signal B_{α,β}.

The signals Hᵢ to be summed optionally do not necessarily need to lie consecutively in series of index value i; for example appropriate scaled and phase-shifted signals Sᵢ for i=1, 10, 12, 15 can be selectively combined to generate the signal B_{α,β}. The angles α and β are susceptible to being defined, for example, as illustrated in FIG. 6. A mathematic mapping relates the angles α, β to corresponding phase shift θᵢ and scaling coefficient Aᵢ are denoted by function G in Equation 3 (Eq. 3):

(θ,A)=G(α,β) Eq. 3

wherein the function G is determined by a geometry and configuration of the transducer array 320. The function G is optionally pre-computed and stored as a mapping in data memory, for example in a form of a look-up table; the look-up table is beneficially stored in at least one of the data processing arrangement 110 and the digital signal processor 310. Alternatively, the function G can be computed in real-time from parameters in at least one of the data processing arrangement 110 and the digital signal processor 310.

The signals B_{α,β} are computed using at least Equations 1 and 2 (Eq. 1 and 2) in real-time and then communicated from the digital signal processor 310 via the communication link 120 to the data processor arrangement 110 for further processing there. Optionally, for example under control from the data processing arrangement 110 communicated via the communication link 120 to the probe assembly 100, the signals Sᵢ are communicated directly in real-time, namely directly streamed, in a substantially unprocessed state via the communication link 120 to the data processing arrangement 110 and a majority of data processing then performed in the data processing arrangement 110.

As elucidated in the foregoing, the system 300 is designed to economize on a way in which an available bandwidth of the communication link 120 is utilized in operation. Data flow reduction is susceptible to being achieved by one or more of following approaches:
(a) by dynamically instructing the probe assembly 100 only to send the signals Sᵢ or the signals B_{α,β} corresponding to radially directions defined by B_{α,β} of special interest, thereby avoiding to process and send data for directions which are not of interest;
(b) by dynamically instructing the digital signal processor 310 only to process signals from a subset of the transducers 460, corresponding to a reduction in angular and spatial resolution, for example by dynamically adjusting values for limit indexes r, s; this saves computing effort and power dissipation within the probe assembly 100;
(c) by dynamically instructing the digital signal processor 310 to send the signals corresponding to B_{α,β} or Sᵢ at a reduced resolution, for example by only sending more significant bits of data bytes whilst maintaining computational accuracy within the digital signal processor 310; and
(d) by performing a fast Fourier transform (FFT) at the digital signal processor 310 of the signal B_{α,β} to generate corresponding Fourier spectrum coefficients F_{α,β} and then by communicating the spectrum coefficients F_{α,β} via the communication link 120 to the data processing arrangement 110, namely by adopting a parameterized data compression process.

Optionally, in approach (d), the digital signal processor 310 is operable to compare, for example by a correlation-type technique or using a neural network approach, the Fourier spectrum coefficients F_{α,β} with templates of frequency spectra of specific types of known defects occurring within boreholes, for example leakage holes, obstructions, cracks and so forth. In an event of the computer frequency spectrum F_{α,β} being sufficiently similar, within a threshold limit, to one or more of the frequency spectra of the one or more templates, a defect in the borehole 10 is deemed to have been found; in such case of finding a defect for the angles α, β, the digital signal processor 310 is operable to simply send an identification that one or more defects have been detected and a nature of the one or more defects. Such an extension of the approach (d) represents considerable data processing in the probe assembly 100 but also provides a very high degree of data compression which potentially enables, for a given bandwidth available in the communication link 120, the probe assembly 100 to be advanced at a greater longitudinal velocity along the borehole 10 whilst simultaneously providing real-time monitoring. In an event that the borehole 10 is mostly free of defects along its length, such an approach as in (d) results in a relatively smaller amount of data exchange along the communication link 120 until a defect is found; in such an event that a defect is found, the system 300 is, for example, capable of dynamically switching from the approach as in (d) to comprehensive sampling of the signal B_{α,β} when the probe assembly 100 is in close proximity to the detected defect and whilst the probe assembly 100 is manoeuvred more slowly relative to the detected defect.

When the system 300 is operated in the first passive mode, a signal B_{α,β} as illustrated in FIG. 7a is often obtained. In FIG. 7a, there is an absence of any drive signal S_{d}, 390 applied to the transducer array 320; such absence is denoted by a horizontal line in FIG. 7a. Noise generated within the borehole 10 is received at the transducer array 320 and gives rise to a resolved noise-like chaotic signal as illustrated in FIG. 7a.

Conversely, when the system 300 is operated in the second active mode, the transducer array 320 is driven with the one or more drive signals S_{d} 390 which are optionally phase shifted and amplitude adjusted so that the transducer array 320 emits a beam of ultrasonic radiation in a preferred direction. Alternatively, the transducer array 320 is driven with the one or more signals S_{d} 390 to emit ultrasonic radiation more omni-directionally from the transducer array 320. The one or more drive signals S_{d} 390 optionally include a temporal sequence of single excitation pulses mutually separated by a time duration Δt; such excitation single pulses approximate to pseudo-Dirac pulses and excite a natural mode of resonance of the transducer array 320 such that the radiation 400 is emitted at a frequency of this natural mode of resonance. Conversely, when the drive signal S_{d} 390 is a periodically repeated sequence of a burst of pulses 600 as illustrated in FIG. 7b, the frequency of the radiation 400 is susceptible to being at least partially defined by a pulse repetition frequency within the burst of pulses 600.

When operating in the second active mode, the burst of pulses 600 results in instantaneous direct signal breakthrough coupling, for example by way of direct electrostatic and/or electromagnetic coupling, giving rise to an initial detected pulse 610 which, optionally, can be gated out without the digital signal processor 310. A pulse wavefront in the radiation 400 propagates from the transducer array 320 to an inside facing surface of the liner tube 30a wherefrom a portion of the radiation 400 is reflected and propagates as a component of the radiation 350 back to the transducer array 320 to give rise to a reflected pulse 620 as shown in FIG. 7b in the resolved signal B_{α,β}. A proportion of the radiation 400 is further coupled into the liner tube 30a and is reflected from an exterior facing surface of the liner tube 30a back through the liner tube 30a and further as another component of the radiation 350 back to the transducer array 320 to give rise after resolving to a weaker pulse 630 as shown in FIG. 7b in the resolved signal B_{α,β}. In an event that an obstruction is present on an inside surface of the liner tube 30a, a pulse corresponding to the obstruction will be observed before the pulse 620. Moreover, in an event that the liner tube 30a is cracked or fractured, reflections forming the pulses 620, 630 will be confused, namely a convoluted and attenuated mixture of signal components. A portion of the radiation 400 is susceptible to propagating through the liner tube 30a and propagating further into a region, for example a cavity, between an external surface of the liner tube 30a and the ground 20; the region represents an abrupt spatial acoustic impedance variation and results in a portion of the radiation thereat being reflected back to the probe assembly 100. The system 300 is thereby capable of performing metrology on such a region between the external surface of the line tube 30a and the ground 20. Such a region is susceptible, for example, to providing a path for leakage of oil and/or gas up the borehole 10 externally to the line tube 30a.

In the first passive mode of operation of the system 300, spectral analysis, for example executed using a form of fast Fourier transform, of acoustic radiation generated by fluid flow through leakage holes and around an exterior of the liner tube 30a enables certain categories of defects to be detected. Conversely, when fluid flow is not occurring within the borehole 10, the second active mode of operation enables other types of defects to be identified. As elucidated in the foregoing, the system 300 is capable of being optimized for operating solely in either the first passive mode or solely in the second active mode. Alternatively, the system 300 is capable of being implemented to be able to function in both the first passive mode and the second active mode; for example, the system 300 is capable of being implemented to dynamically switch between the first and second modes in real-time when making measurements within the borehole 10.

Optionally, in order to reduce a quantity of data to be communicated via the communication link 120 when the system 300 is operating in the second active mode, the digital signal processor 310 is optionally configurable from the data processing arrangement 110 to analyze the signal B_{α,β} to identify times tₚ when reflection pulses, for example the pulse 620, 630, occur after their corresponding excitation burst of pulses 600 or single excitation pulse, and to determine their corresponding amplitudes U, and then communicate time of reflected pulse information tₙ and corresponding amplitude U as descriptive parameters via the communication link 120 to the data processing arrangement 110, thereby achieving potentially considerable data compression in comparison to communicating the signal B_{α,β} directly to the data processing arrangement 110; a rate at which the probe assembly 100 is capable of being advanced along the borehole is thereby potentially considerably enhanced in real-time when data compression is utilized.

Operation of the data processing arrangement 110 will now be further elucidated. When data is communicated from the probe assembly 100 via the communication link 120 to the data processing arrangement 110, the processing arrangement 110 is optionally operable to record the received data from the probe assembly 100 as a data log in the data memory 140. Such a record enables, for example, subsequent analysis to be performed after the probe assembly 100 has been extracted from the borehole 10, for example to perform noise reduction operations for increasing a certainty of detection of various types of defects in the borehole 10. The data processor 330 is operable to execute one or more software products which apply further analysis and conditioning of data received via the communication link 120 from the probe assembly 100.

In real-time, when the system 300 is functioning in the second mode of operation, the data processor 330 presents on the display 130 a local 3-dimensional view of an interior of the borehole 10 substantially at a depth z at which the probe assembly 100 is positioned within the borehole 10, for example refer to FIGS. 2, 3 and 5 for a definition of the depth z; in FIG. 5, increasing depth z is in an upward direction in the drawing. Such representation on the display 130 in the second active mode of operation enables the one or more users 450 to visually spatially inspect the inside surface of the liner tube 30a in real-time. Time instances of receipt, for example, of the reflected pulses 620, 630 at the transducer array 320 provides an indication of the spatial location of the inside and outside surfaces of the liner tube 30a and also potentially an ultrasonic radiation view of material surrounding an exterior of the liner tube 30a.

Alternatively, in the first passive mode of operation of the system 300, there is provided an indication of potential defects or ultrasonic noise sources as a function of the depth z and the angles α, β, see FIG. 6. A different type of presentation is then optionally provided on the display 130 illustrating identified defect and/or noise type as a function of radial position as defined by the angles α, β, and the depth z.

When the system 300 is configured to function in the second active mode, the data processor 330 employs one or more software products which operate to map the signal B_{α,β} by a mapping function M to a Cartesian or a polar coordinate data array, namely w (x, y, z) or w (α, β, z), as denoted as a mapping step 700 in FIG. 8 and described by Equation 4 (Eq. 4):

w(x, y, z)=M(B_{α,β}, z)

w(α,β,z)=M(B_{α,β}, z) Eq. 4

Values stored in elements w of the data array correspond to strength of reflected ultrasonic radiation, namely aforementioned U, as determined from reflection pulse peak amplitude in the signal B_{α,β}.

The signal B_{α,β}, for example as illustrated in FIG. 7b, is optionally communicated to the data processing arrangement 110 in data-compressed in a parameterized form as elucidated earlier. By action of the mapping function M, the data array w thereby has stored therein a spatial crude 3-dimensional image of an inside view of the borehole 10 wherein an array element w position is equivalent to a corresponding spatial position within the borehole 10.

Thereafter, in a gradient computation step 710, the data processor 330 is operable to apply a gradient-determining function to determine 3-dimensional gradients in element w signal amplitude values stored in the data array w (x, y, z) or w (α, β, z), namely to determine whereat spatial boundaries between features are present in the ultrasonic image of the borehole 10 recorded in the data array w. Identification of spatial boundaries is also known as “iso-surface extraction” in the technical art of image processing and involves computation of partial differentials of the array elements w as provided in Equation 5 (Eq. 5):

$$\frac{\partial w}{\partial x} , \frac{\partial w}{\partial y} , \frac{\partial w}{\partial z} or \frac{\partial w}{\partial α} , \frac{\partial w}{\partial β} , \frac{\partial w}{\partial z} \qquad Eq . 5$$

depending upon whether Cartesian or polar coordinate systems are employed.

In a step 720, the one or more software products are then operable to enhance values in the data array w, for example by curve fitting techniques, to show more clearly whereat continuous boundaries occur in the elements w (x, y, z) or w (α, β, z) stored image data store in the data memory of the data processor 330. Such curve fitting operations offer a smoothing function so that images presented on the display 130 are not cluttered with irrelevant surface texture details, but nevertheless show relevant features regarding integrity and operation of the borehole 10. Optionally, a step of smoothing is alternatively performed before a step of extracting iso-surfaces is performed.

Thereafter, in a step 730, the data processor 330 is operable to read data from the element w of the data array and then write corresponding presentation values, after geometrical transformation when necessary, into a memory buffer serving the display 130.

Optionally, in an event that the one or more software products executing on the data processor 330 identify when extrapolating one or more boundaries in the image stored in the elements w of the data memory to be unclear, the data processor 330 is then operable in real-time to instruct, as denoted by 740, the digital signal processor 310 for specific values of the angles α, β to repeat measurements within the borehole 10 for resolving such lack of clarity in the image stored at the data processor 330. Such instruction to the digital signal processor 310 optionally includes one or more of:
(a) causing the probe assembly 100 to employ its digital signal processor 310 to appropriately phase shift and scale pursuant to Equations 1 and 2 (Eqs. 1 and 2) more of its electrical signals Sᵢ to generate corresponding values of the signal B_{α,β} thereby having greater directional definition and resolution, the signals B_{α,β} being subsequently communicated to the data processing arrangement 110 for further data processing and subsequent presentation on the display 130;
(b) averaging, namely filtering, over numerous samples of the signal Sᵢ to reduce noise for a limited range of specified angular sensing directions defined by the angles α, β, and then computing corresponding signals B_{α,β} for communicating via the communication link 120 to the data processing arrangement 110 for subsequent further data processing thereat and thereafter presentation on the display 130;
(c) driving the transducer array 320 in the manner of a phased array so that more of its ultrasonic radiation 400 is delivered into a particular direction in which metrology and monitoring was previously unclear, acquiring further vales of the signal Sᵢ and subsequently computing corresponding signals B_{α,β} for communication to the data processing arrangement 110 for further data processing at the data processing arrangement 110 and thereafter presentation on the display 130; and
(d) acquiring a larger set of measurements over a given defined limited range of angles α, β so as to map out finer details of a feature present in the borehole 10, processing corresponding acquired signals Sᵢ to generate corresponding signals B_{α,β}, communicating the signals B_{α,β} via the communication link 120 to the data processing arrangement 110 for further data processing and eventual presentation on the display 130.

Beneficially, one or more of the users 450 as well as the data processing steps as illustrated in FIG. 8 are able to invoke a reconfiguration of the probe assembly 100 to acquire enhanced information from one or more regions of the borehole 10. After the enhanced information is acquired b the system 300, the system 300 is beneficially operable to revert back to its previous configuration state to continue monitoring the borehole 10. Thus, during monitoring operations involving manoeuvring the probe assembly 100 of the system 300 along the borehole 10, the system 300 is optionally set to perform a method comprising steps of:
(a) performing a series of spatially coarse measurements along the borehole 10 whilst monitoring in real-time for any trace of one or more defects or other unusual features in the borehole 10;
(b) detecting one or more potential defects or other unusual features at a location along the borehole 10 in real-time;
(c) reconfiguring the probe assembly 100 to perform a selective more detailed series of measurements of the one or more defects or other unusual features; and
(d) after executing the more detailed series of measurements in step (c), resuming the series of spatially coarse measurements along the borehole 10 as in step (a).

This method is capable of being employed when the system 300 is operating in its first passive mode or in its second active mode. Optionally, the system 300 is beneficially operable to dynamically switch in real-time between the first and second modes when performing the series of spatially coarse measurements along the borehole 10.

It will be appreciated that the system 300 is operable to provide 2-D images of an inside of the liner tube 30a, and also information of a region between an outside of the liner tube 30a and the ground 20, for example an existence of voids or cavities, Moreover, the system 300 is capable of generating 3-D views, for example perspective views on planar screens such as liquid crystal pixel display screens, which are most readily interpreted by human visual viewing.

It will be appreciated that embodiments of the invention as described in the foregoing are susceptible to being modified without departing from the scope of the invention as defined by the appended claims.

Beneficially, the probe assembly 100 is furnished with one or more pressure sensors for measuring a pressure P present within the borehole 10 as the probe assembly 100 is manoeuvred in operation along the borehole 10. In an event that the probe assembly 100 detects that the pressure P in the borehole 10 becoming excessive, for example in excess of 500 Bar, the probe assembly 100 is operable to transmit a warning message to the one or more users 450.

Beneficially, the probe assembly 100 is furnished with a temperature sensor for measuring an operating temperature T within the probe assembly 100. In an event that the operating temperature T exceeds a predefined threshold temperature Th, the probe assembly 100 is operable to send a request to the data processing arrangement 110 to enable the probe assembly 100 to assume intermittent operation, wherein the digital signal processor 310 is permitted intermittently to enter a hibernating low-power state in order to provide the digital signal processor 310 with an opportunity to cool slightly by reducing electrical power dissipation therein. When in the hibernating state, advance of the probe assembly 100 along the borehole 10 is optionally temporarily halted. Optionally, such intermittent operation of the signal processor 310 is progressively more adopted as the operating temperature T exceeds above the threshold temperature Th. Beneficially, the data processing arrangement 110 is susceptible to being instructed to temporarily assume a hibernating state during which its power dissipation is reduced in comparison to its normal non-hibernating operation.

The transducer array 320 is described briefly in the foregoing. In FIG. 9, there is shown an illustration of the probe assembly 100, wherein the array 320 is susceptible to being implemented in various configurations, for example at least one of:
(a) a rectangular matrix 800 of mutually perpendicular rows and columns of individual transducer elements, for example cut from a single slab of polarized piezo-electric material, for example by using a fine diamond saw; peripheral edges of the matrix 800 are optionally straight or curved; the rectangular matrix is beneficially mounted at a bottom surface of the probe assembly 100 facing down the borehole 10 when the probe assembly 100 is in operation;
(b) a series of individual transducer elements arranged in one or more ring formations 810; the ring formation is beneficially mounted at one or more ends of the probe assembly 100, or radially around an radial side wall of the probe assembly 100; and
(c) in one or more rows 830 or a spiral formation 840 around a peripheral surface of the probe assembly 100 in a substantially longitudinal direction along the probe assembly 100.

Optionally, the probe assembly 100 further includes an electronic compass for measuring a direction of the Earth's north and south magnetic poles at the probe assembly 100 in order to provide a corresponding orientation signal for communicating via the communication link 120 to the data processing arrangement 110; receipt of such an orientation signal enables the data processor 330 to correct for the angle β as shown in FIG. 6 when the probe assembly 100 is lowered into the borehole 10 and revolves during its descent into or during subsequent extraction from the borehole 10. The probe assembly 100 is thus beneficially fabricated from non-ferromagnetic materials, for example non-magnetic stainless steel.

The probe assembly 100 beneficially has an exterior diameter “d” in a range of 100 mm to 180 mm, more beneficially a diameter in a range of 120 mm to 160 mm, and most beneficially substantially a diameter of substantially 150 mm. Moreover, the probe assembly 100 beneficially has a longitudinal length “L”, disregarding attachment of the cladding 200 and its associated communication link 120, in a range of 0.5 metres to 5 metres, more beneficially in a range of 1 metre to 3 metres and beneficially substantially 1.5 metres.

The system 300 is capable of being adapted to perform one or more of the following functions:
(a) Well leak detection, wherein the system 300 is operable to function as a Well Leak

Detector (WLD). Leak depth accuracy to within an order of a centimetre is feasible. Moreover, leak rates in a range of 0.02 litres/minute to 300 litres/minute are susceptible to being detected and monitored by using the system 300; leak detection in production packers, expansion joints, tubing, down-borehole 10 safety valves, one or more casings in a well associated with the borehole 10, and in a wellhead associated with the borehole 10 are susceptible to being monitored using the system 300; in operation, it is often not necessary when using the system 300 in the borehole 10 to pull drill-string tubing up for identifying and monitoring a failing barrier in a well;
(b) Well sand detection, wherein the system 300 is operable to function as a Well Sand Detector (WSD). Sand is probably a biggest challenge to operators in the oil industry.

Sand fills up the borehole 10 and chokes back productivity of the borehole 10 when used for oil extraction. Sand erodes well equipment and facilities, causing breakdown and sometimes causing blowouts. The system 300 is susceptible to being used to identify sand-producing regions of geological strata, namely sand-producing intervals, and is also susceptible to being used to identify failures in sand control devices employed in conjunction with sand control for the borehole 10 when used to extract oil. Beneficially, the probe assembly 100 is implemented such that its housing has a relatively smaller diameter, for example in a range of 40 mm to 80 mm, when adapted specifically for well sand detection. Acoustic energy is generated in the housing when sand particles impact upon the casing when the probe assembly 100 is in use, wherein the acoustic energy has a characteristic frequency spectrum by which the sand can be identified; at least a portion of the transducer array 320 is then specifically adapted for sensing such acoustic radiation resulting from sand impact on the probe assembly 100;
(c) Well flow detection, wherein the system 300 is operable to function as a Well Flow

Detector (WFD); the system 300 configured to function as a well flow detector is susceptible in operation to providing detailed information about an inflow profile from the borehole 10 when used for oil extraction, for example for providing relative velocity profiles between different producing or injecting intervals of the borehole 10, for example those intervals which are not contributing at all to oil extraction; and
(d) Well annular flow detection, wherein the system 300 is operable to function as a Well Annular Flow monitor (WAF); the system 300 operable as the Well Annular Flow monitor is capable of detecting and locating flow behind a pipe in an annulus between a liner tube, namely casing, and a geological formation; the system 300 is thereby operable to detect contamination of groundwater, one or more underground blowouts, sustaining liner tube pressure, one or more undesirable water cuts, and one or more undesirable gas cuts when drilling the borehole 10.

The system 300 is optionally optimized to perform one of functions (a) to (d). Alternatively, the system 300 can be optimally designed to perform several of these functions and to dynamically switch between such functions when in use. Certain of the functions (a) to (d) are serviced in the aforementioned first passive mode, whereas other of the functions (a) to (d) are addressed by the system 300 operating in its second active mode. In general, a cost and complexity of the system 300 increases as it is required to be more versatile in dynamically performing diverse functions.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Numerals included within parentheses in the accompanying claims are intended to assist understanding of the claims and should not be construed in any way to limit subject matter claimed by these claims.

1. A monitoring system (300) for monitoring within a borehole (10), said system (300) comprising a probe assembly (100) operable to be moved within said borehole (10) for sensing one or more physical parameters therein, a data processing arrangement (110) being located outside the borehole (10), and a data communication link (120) operable to convey sensor data indicative of said one or more physical parameters from the probe assembly (100) to the data processing arrangement (110) for subsequent processing and display and/or recording in data memory (140),
characterized in that
(a) said probe assembly (100) includes one or more sensors (320) for spatially monitoring within the borehole (10) and generating corresponding sensor signals (360);
(b) said probe assembly (100) includes a digital signal processor (310) for executing preliminary processing of the sensor signals (360) to generate corresponding intermediately processed signals (370) for communication via said data communication link (120) to the data processing arrangement (110);
(c) said data processing arrangement (110) is operable to receive said intermediately processed signals (370) and to perform further processing on said intermediately processed signals (370) to generate output data for presentation (130) and/or for recording in a data memory arrangement (140).

2. A monitoring system (300) as claimed in claim 1, said system (300) being operable to generate said output data for presentation (130) in real-time when said probe assembly (100) is moved within the borehole (10).

3. A monitoring system (300) as claimed in claim 1 or 2, wherein said system (300) is operable in at least one of first and second modes, wherein:
(a) said first mode results in said system (300) passively sensing noise sources present in the borehole (30) generating radiation (350) for sensing at the one or more sensors (320); and
(b) said second mode results in said system (300) actively emitting radiation into the borehole (10) and receiving at said one or more sensors (320) corresponding reflected radiation from a region in and/or around the borehole (10) for generating said sensor signals (360).

4. A monitoring system (300) as claimed in claim 3, wherein said system (300) is operable to be dynamically reconfigurable between said first and second modes when said probe assembly (100) is being moved in operation within said borehole (10).

5. A monitoring system (300) as claimed in claim 1, wherein said system (300) is operable to communicate data bi-directionally between said data processing arrangement (110) and said probe assembly (100), wherein said digital signal processor (310) of said probe assembly (100) is operable to being reconfigured between a first function of general sensing around in a region of the borehole (10) in a vicinity of the probe assembly (100), and a second function of specific sensing in a sub-region of said region of the borehole (10) in a vicinity of the probe assembly (100).

6. A monitoring system (300) as claimed in claim 1, wherein said one or more sensors (320) are implemented as one or more ultrasonic transducer arrays disposed at one or more positions on the probe assembly (100) including:
(a) as an array at a bottom surface of the probe assembly (100) facing down the borehole (10) when the probe assembly (100) in inserted into the borehole (10) in operation;
(b) one or more ring formations (810) at one or more ends of the probe assembly (100), or radially around an radial side wall of the probe assembly (100);
(c) in one or more rows (830) or one or more spiral formations (840) around a peripheral surface of the probe assembly (100) in a substantially longitudinal direction along the probe assembly (100).

7. A monitoring system (300) as claimed in claim 1, wherein said system (300) is operable to process the sensor signals (360) and compare the processed signals with one or more signal templates for automatically detecting features present in the borehole (10) which are encountered in operation by the probe assembly (100).

8. A monitoring system (300) as claimed in claim 1, wherein said data communication link (120) is implemented using one or more twisted-wire pairs including plastics material insulation and copper electric conductors embedded within said plastics material, the data communication link (120) being clad by cladding (200) susceptible to bearing a weight of the probe assembly (100) when said assembly (100) is moved in operation within the borehole (10).

9. A monitoring system (300) as claimed in claim 1, wherein said data communication link (120) is implemented using one or more twisted-wire pairs including plastics material insulation and copper electric conductors embedded within said plastics material, the data communication link (120) being provided with an associated mechanical element susceptible to bearing a weight of the probe assembly (100) when said assembly (100) is moved in operation within the borehole (10).

10. A monitoring system (300) as claimed in claim 1, wherein said data processing arrangement (110) is located in operation remotely from the probe assembly (100), said data processing arrangement (110) providing an interface for one or more users (450) to control in real-time operation of the probe assembly, and for generating graphical images for presentation on one or more displays (130) to the one or more users (450), said graphical images being representative of spatial features present within and/or around said borehole (10) in a vicinity of said probe assembly (100).

11. A method of monitoring within a borehole (10) by using a monitoring system (300), said system (300) comprising a probe assembly (100) operable to be moved within said borehole (10) for sensing one or more physical parameters therein, a data processing arrangement (110) located outside the borehole (10), and a data communication link (120) operable to convey sensor data indicative of said one or more physical parameters from the probe assembly (100) to the data processing arrangement (110) for subsequent processing and display and/or recording in data memory,
characterized in that said method includes steps of:
(a) spatially monitoring using one or more sensors (320) of said probe assembly (100) within the borehole (10) and generating corresponding sensor signals (360);
(b) using a digital signal processor (310) included in said probe assembly (100), executing preliminary processing of the sensor signals (360) for generating corresponding intermediately processed signals (370);
(c) communicating via said data communication link (120) said intermediately processed signals (370) to the data processing arrangement (110); and
(d) receiving said intermediately processed signals (370) at said data processing arrangement (110) for performing further processing on said intermediately processed signals (370) for generating output data for presentation (130) and/or for recording in a data memory arrangement (140).

12. A method as claimed in claim 11, including a further step of:
(e) generating using said system (300) said output data for presentation (130) in real-time when said probe assembly (100) is moved within the borehole (10).

13. A method as claimed in claim 11 or 12, said method including a step of operating said monitoring system (300) in at least one of first and second modes, wherein:
(a) said first mode results in said system (300) passively sensing noise sources present in the borehole (30) generating radiation (350) for sensing at the one or more sensors (320); and
(b) said second mode results in said system (300) actively emitting radiation into the borehole (10) and receiving at said one or more sensors (320) corresponding reflected radiation from a region in and/or around the borehole (10) for generating said sensor signals (360).

14. A method as claimed in claim 13, wherein said method includes a further step of dynamically reconfiguring said system (300) between said first and second modes when said probe assembly (100) is being moved in operation within said borehole (10).

15. A method as claimed in claim 11, wherein said method includes a step of:
(f) communicating data bi-directionally between said data processing arrangement (110) and said probe assembly (100), wherein said digital signal processor (310) of said probe assembly (100) is operable to being reconfigured between a first function of generally sensing around in a region of the borehole (10) in a vicinity of the probe assembly (100), and a second function of specific sensing in a sub-region of said region of the borehole (10) in a vicinity of the probe assembly (100).

16. A method as claimed in claim 11, wherein said one or more sensors (320) are implemented as one or more ultrasonic transducer arrays disposed at one or more positions on the probe assembly (100) including:
(a) as an array at a bottom surface of the probe assembly (100) facing down the borehole (10) when the probe assembly (100) in inserted into the borehole (10) in operation;
(b) one or more ring formations (810) at one or more ends of the probe assembly (100), or radially around an radial side wall of the probe assembly (100);
(c) in one or more rows (830) or one or more spiral formations (840) around a peripheral surface of the probe assembly (100) in a substantially longitudinal direction along the probe assembly (100).

17. A method as claimed in claim 11, wherein said method includes a further step of:
(g) processing the sensor signals (360) to generate corresponding processed signals; and then
(h) comparing the processed signals with one or more signal templates for automatically detecting features present in the borehole (10) which are encountered in operation by the probe assembly (100).

18. A method as claimed in claim 11, wherein said data communication link (120) is implemented using one or more twisted-wire pairs including plastics material insulation and copper electric conductors embedded within said plastics material, the data communication link (120) being clad by cladding (200) susceptible to bearing a weight of the probe assembly (100) when said assembly (100) moved in operation within the borehole (10).

19. A method as claimed in claim 11, wherein said method includes a step of:
(i) locating said data processing arrangement (110) in operation remotely from the probe assembly (100), said data processing arrangement (110) providing an interface for one or more users (450) to control in real-time operation of the probe assembly, and for generating graphical images for presentation on one or more displays (130) to the one or more users (450), said graphical images being representative of spatial features present within and/or around said borehole (10) in a vicinity of said probe assembly (100).

20. A computer software product recorded on a data carrier, said computer software product being executable on computing hardware for implementing a method as claimed in claim 11.

21. A probe assembly (100) for use in monitoring within a borehole (10), said probe assembly (100) being adapted for use in a monitoring system (300) as claimed in claim 1.
